(19) United States
(12) Patent Application Publication
(10) Pub. No.: US 2025/0316983 A1
(43) Pub. Date: Oct. 9, 2025

(54) Stabilizing Voltage and Frequency at a Point of Common Coupling of an Industrial Facility

(71) Applicant: ABB Schweiz AG, Baden (CH)

(72) Inventors: Nandhakumar Vijayakumar, Nussbaumen (CH); Rajesh Pai, Gebenstorf (CH)

(21) Appl. No.: 18/863,083

(22) PCT Filed: May 13, 2022
(86) PCT No.: PCT/EP2022/063029

§ 371 Date: Nov. 5, 2024

(51) Int. Cl. H02J 3/14; H02J 3/00; H02J 3/18; H02J 3/28

(52) U.S. Cl. CPC H02J 3/144; H02J 3/003; H02J 3/1864; H02J 3/28; H02J 2310/10

(57) ABSTRACT

An industrial facility connected to a power grid includes a distribution grid connected with the power grid at a point of common coupling; at least one load connected via at least one power electronics block to the distribution grid, each power electronics block adapted for converting a current from the distribution grid into a current supplied to the respective load and each power electronics block including a load responder component adapted for determining a load demand of the respective load; at least one compensator connected to the distribution grid, each compensator being adapted for stabilizing a voltage and/or a frequency of a current in the distribution grid and each compensator including a compensator responder component adapted for receiving a stabilizing command and for applying the stabilizing command to the respective compensator; and a power controller in data communication with the one or more load responder components and the one or more compensator responder components, the power controller being adapted for receiving load demands(50) from the one or more load responder components, for determining stabilizing commands from the load demands and for sending the stabilizing commands to the one or more compensator responder components.

### TECHNICAL FIELD

The invention relates to an industrial facility connected to a power grid. The invention further relates to a method, a computer program, a computer-readable medium and a controller for stabilizing a voltage and/or a frequency at a point of common coupling of the industrial facility with the power grid.

### BACKGROUND OF THE INVENTION

Variable energy sources-based grids are power electronics dependent, and when their contribution is high, such grids may be termed Power Electronics Dominated Grids (PEDG). These grids are characterized by varying grid strength, low and varying inertia, and low short circuit power. For example, due to weather dependency of some variable energy sources, the power generation mix may constantly change.

Operation in these grids is subjected to steady state and transient stability challenges. In particular, transient events on the grid and load sides may have profound impact due to fast change in active and reactive power, impacting the system voltage and frequency.

On the contrary to a traditional grid, voltage and frequency may be tightly coupled in a PEDG. This tight coupling may amplify the impact of transient events resulting in voltage and frequency stability issues.

Transient events include load rejection of hydrogen production units, load rejection of electric arc furnace, inrush currents of high-power converter transformers, instabilities due to arc, load side symmetrical and asymmetrical faults, grid side symmetrical and asymmetrical faults, load shedding, etc. During the aforementioned transient events, which include rapid changes in active and reactive power, the supply and demand balance may be disturbed, leading to voltage and frequency changes. In traditional, strong grids, changes in power components do not affect the system voltage and frequency. However, in a PEDG, such a scenario may lead to widespread industrial facility and grid disturbances.

US 2008/278 000 A1 describes an internal grid connected to loads and sources, which is connected to a large-scale grid. A universal interconnect device interconnecting the internal grid with the large-scale grid comprises a power quality compensator for absorbing or generating reactive power and an energy storage device for absorbing and generating active power. In such a way, the universal interconnect device can stabilize frequency and regulate voltage in the internal grid.

The article of P. K. S Ayivor et al: “Modelling of Large Size Electrolyzer for Electrical Grid Stability Studies in Real Time Digital Simulation”, 3rd International Hybrid Power Systems Workshop, 1 Jan. 2018 (2018-01-01), pages 1-8, describes how to simulate an electrolyzer to model their power input drawn from an electrical grid.

US 2014/103 727 A1 describes an island grid power supply with a controller that is adapted for communicating via fibre optics lines.

U.S. Pat. No. 6,274,851 B1 describes a controller for an electric arc furnace.

US 2003/076 075 A1 shows a system for stabilizing voltage in an electric arc furnace by changing reactive power by controlling an adjustable reactance device.

EP 2 437 370 A2 describes an industrial controller adapted for goal based load management in an industrial facility having several loads.

### SUMMARY

It is an object of the invention to provide a control system and a control method, which allows the operation of an industrial facility with strong and/or dynamically varying loads at a weak grid, in particular a grid mainly supplied by renewable energy sources and power-electronics blocks feeding the electric arc furnace.

This objective is achieved by the subject-matter of the independent claims. Further exemplary embodiments are evident from the dependent claims and the following description.

A first aspect of the invention relates to an industrial facility connected to a power grid. The industrial facility may comprise electric loads and/or is adapted for processing medium voltages, such as voltages of more than 6 kV and/or high currents, such as more than 100 A. Power electric components of the power electric system and/or the industrial facility may be distribution grids, power electronics blocks, such as inverters, rectifiers and converters, passive and active filters, power loads and power sources. Such power loads may be any electric devices consuming electric power, such as motors, arc furnaces, etc. Such power sources may be any electric devices providing electric power, such as battery storage systems, fuel cells, etc.

The power grid may be supplied by renewable energy sources and/or varying power sources.

According to an embodiment of the invention, the industrial facility comprises a distribution grid connected with the power grid at a point of common coupling. The distribution grid may comprise one or more electric cables for connecting the point of common coupling with power electric components of the industrial facility. The point of common coupling may be a point where the industrial facility interfaces with a public network or an energy service provider. The point of common coupling may be at a high voltage or medium voltage bus or a substation.

The distribution grid may connect the loads and sources and further power electric components with the power grid. On the one hand, the voltage and/or frequency of the electric power at the point of common coupling may be varying due to instabilities in the power grid. On the other hand, the voltage and/or frequency of the electric power at the point of common coupling may be varying due to changing load demands of the industrial facility. With the system and method described herein, the voltage and/or frequency at the point of common coupling may be stabilized by according to control of the components of the industrial facility. For example, this may be beneficial, when the industrial facility comprises a hydrogen fed ore pelletizing plant with or without electric arc furnace. Without the control and system as described herein, a weak unstable grid may be destabilized by the operation of the pelletizing plant and/or the arc furnace, especially during transient events until the industrial facility or at least components thereof have to be ramped down or switched off due to stability reasons.

According to an embodiment of the invention, the industrial facility comprises at least one load connected via at least one power electronics block to the distribution grid. A load may be any electric device consuming electric power. There may be one or more power electronics block per load. Each power electronics block is adapted for converting a current from the distribution grid into a current supplied to the respective load. A power electronics block may be of naturally or forced commutated converter types. They can also be direct or indirect converter types. For example, a power electronics block may be a rectifier, inverter, or converter. A power electronics block may comprise power semiconductor switches, which may be controlled to provide the functionality of the power electronics block.

According to an embodiment of the invention, each power electronics block comprises a load responder component adapted for fulfilling and/or determining a load demand of the respective load. In general, the load responder component may be a part of a controller of the power electronics block. The load responder component may be a module, such as a hardware or software module of the controller. The load responder determines a load demand of the load, such as a power need of the load, which may refer to active and/or reactive power, and/or a power quality issue, such as harmonics, power factor, flicker etc. . . . This load demand may be sent via a data communication line to a central controller and/or power controller to be further processed.

The load responder component may determine further information, such as state change information of the load, for example, that load will increase and/or decrease its power demand in the future. The load responder component also may determine electric measurement information, such as the active and reactive power, at the input of the load, etc.

The load responder component also may receive power control information about the distribution grid, such as that the loads should reduce its power demand in the future. For example, the industrial facility may receive the information that power sources may be disconnected from the power grid and therefore the industrial facility has to reduce its power demand. The power control information may be received via a data communication line from a central controller and/or power controller.

According to an embodiment of the invention, the industrial facility comprises at least one compensator connected to the distribution grid. Each compensator is adapted for stabilizing a voltage and/or a frequency in the distribution grid. A compensator may be any electric device stabilizing the voltage and/or frequency of the distribution grid and therefore of the power grid. It has to be noted that there may be loads, which are also compensators, such as a motor that may be operated as generator. Compensators may comprise power sources, filters, reactors, etc.

Different compensators may react with different speeds on changes in the grid. A controllable electric filter may react quicker on load changes as compared to an energy storage system and/or a mechanical compensator. A quicker inertia support may be provided by a synchronous condenser as compared to an energy storage system.

According to an embodiment of the invention, each compensator comprises a compensator responder component adapted for receiving a stabilizing command and for applying the stabilizing command to the respective compensator.

In general, the compensator responder component may be a part of a controller of the compensator. The compensator responder component may be a module, such as a hardware or software module of the controller.

The stabilizing command may be information on stabilizing the voltage and/or frequency in the distribution grid. For example, it may comprise a command for increasing or decreasing the voltage or providing active or reactive power support. The stabilizing command may be executed by the respective compensator via the control of the compensator responder component. The stabilizing command may be received via a data communication line from a central controller and/or power controller.

The compensator responder component may determine further information, such as state change information of the compensator, for example, that the compensator, such as an energy storage, is depleted. The compensator responder component also may determine electric measurement information, such as the active and reactive power, at the input of the compensator, etc. The electric measurement information may be sent via a data communication line to a central controller and/or power controller to be further processed.

According to an embodiment of the invention, the industrial facility comprises a power controller in data communication with the one or more load responder components and the one or more compensator responder components. All the data, such as the load demands, the state change information and/or the electric measurement information received from the responder components, may be processed by the power controller to control the voltage and/or frequency in the distribution grid. From the received data, the power controller determines the stabilizing command and/or power control information and sends them to the respective responder components.

This may be done by adjusting set points for the loads and compensators, i.e., the stabilizing commands and/or power control information may comprise setpoints for the respective load and/or compensator. The set points of normal operation may be communicated from the power controller to all load and compensator responders. The power controller also receives measurements from the distribution grid. The power controller maintains a model of the distribution grid, the loads and the compensators. In the case, voltage and/or frequency of the distribution grid leave predefined limits, the power controller adjusts the setpoints, such that voltage and/or frequency stay within these limits. To this end, the measurements and/or the model may be used. According to an embodiment of the invention, the power controller is adapted for receiving load demands from the one or more load responder components, for determining stabilizing commands from the load demands and for sending the stabilizing commands to the one or more compensator responder components.

Disturbances in the power grid and the industrial facility may cause a rapid change in active and reactive power at the point of common coupling. This fast variation may cause voltage and frequency fluctuations affecting the power grid and the process stability of the industrial facility. To compensate this, the industrial facility comprises a combination of controllable loads and compensators with respective load responder components and compensator responder components, which are coordinated by the power controller. This configuration performs the power balancing response by injecting and/or absorbing and/or providing inertial power to maintain the voltage and frequency within the allowed limits.

Inertial power may be connected to frequency and active power. When there is a disturbance, for example like a load rejection in a low inertia system, it may affect the frequency instantaneously due to an active power mismatch. In a traditional grid, a synchronous machine may provide automatic inertia support due to the kinetic energy stored in their rotor. This arrests the instantaneous fall of the frequency. In a distribution grid, which is power electronics dependent, the inertial support provided by a synchronous machine may be missing. In this case, inertial support from the load side may arrest the instantaneous rise or fall of the frequency due to the disturbance. Synchronous condenser may provide an automatic inertia support, since it is directly connected to the distribution grid. As a further measure, other elements, for example hydrogen production units, can be ramped up or down to provide frequency support by varying their active power consumption. A first response may be done via a synchronous condenser, a next response may be done via hydrogen production units, whereby their active power consumption is adjusted.

According to an embodiment of the invention, the power controller is connected with the one or more load responder components and the one or more compensator responder components via data communication lines adapted for transmitting data packages within less than 25 μs. Such a data communication line may be termed fast data communication line or high-speed data communication line. The data communication may be as fast, that the control system, including the power controller and the responder components, is adapted for reaction on changes in voltage and/or frequency, such that a direct control of the instantaneous voltage in the distribution grid is possible. In other words, the data communication may be as fast, such that reactions can be implemented faster as than a period of the voltage in the distribution grid. In such a way, the power controller can coordinate the individual load responder components and compensator responder components by a high-speed point-to-point connection.

According to an embodiment of the invention, the power controller is connected with the one or more load responder components and the one or more compensator responder components via fibre optics data communication lines. Fibre optics lines, which may be made of glass, are adapted for providing fast data communication, such as described above.

According to an embodiment of the invention, one of the at least one compensator is a controlled electric compensator comprising at least one of a resistor, inductor, and capacitor. An example for such a controlled compensator providing active power compensators is a static watt compensator.

In general, controlled compensators for reactive power include synchronous condenser, static var compensator, static synchronous compensator, dynamic voltage restorer, unified power flow controller, interline power flow controller, etc.

According to an embodiment of the invention, one of the at least one compensator is a controlled mechanical compensator comprising a rotating inertia element, such as a heavy drum driven by an electric motor/generator together with or without a converter and/or power electronics block for controlling the energy flow from the distribution grid into the drum and vice versa. Such a device may be a synchronous condenser with or without flywheel and/or may provide rotating inertia.

According to an embodiment of the invention, one of the at least one compensator is a controlled energy storage system, such as a capacitor bank, a battery bank and/or a fuel cell connected to a hydrogen tank. The energy storage system also may comprise a converter and/or power electronics block for controlling the energy flow from the distribution grid into energy storage elements and vice versa.

According to an embodiment of the invention, each of the one or more power electronics block comprises at least one of a rectifier and inverter. In general, a power electronics block may be composed of power electronic components, such as diodes, thyristors, and transistors, which are controlled by a respective controller. This controller may provide the responder component.

According to an embodiment of the invention, one of the at least one load is an arc furnace. An arc furnace may produce heavy disturbances in the distribution grid and may be compensated by the control system as described herein.

According to an embodiment of the invention, one of the at least one load comprises an electrolyser bank and/or fuel cell. The electrolyser bank may be used for converting electrical energy into chemical energy stored in a hydrogen tank. The hydrogen can be converted back into electrical energy by the fuel cell. Such a load also can be seen as a compensator.

According to an embodiment of the invention, the industrial facility also may comprise a hydrogen fed ore pelletizing plant, which is supplied by hydrogen from the hydrogen tank. In such a way, an energy surplus from the power grid may be compensated by producing hydrogen, which later can be used for supplying the ore pelletizing plant or can be used for producing power via a fuel cell.

According to an embodiment of the invention, the industrial facility further comprises an automation controller adapted for controlling the loads. The automation controller may be a PLC controller (programmable logic controller). The automation controller may be used for coordinating the process requirements with the components, such as the loads, that are controlling the process of the industrial facility. The automation controller functions as a superimposed controller. The automation controller usually contains and/or determines process information like set points that are used to maintain the process as well as to perform process related emergency actions via the controlling components.

The automation controller is in data communication with the power controller, for example via a data communication line, with slower data communication than the data communication between the power controller and the responder components. For example, the automation controller may be connected with the power controller via a field bus. In such a way, the power controller coordinates with the automation controller as well as with the utility to provide steady state support.

According to an embodiment of the invention, the industrial facility further comprises a utility interface for receiving external data provided to the industrial facility. Also, the utility interface may be in data communication with the power controller. The utility interface may be used for receiving information about the power grid, such as power sources connecting and disconnecting from the power grid, etc. Such information also may be used for coordinating the loads and compensators.

A further aspect of the invention relates to a method for stabilizing voltage and/or frequency at a point of common coupling of an industrial facility with a power grid. The method may be performed by the power controller together with the responder components and/or more general the controllers of the loads and compensators.

According to an embodiment of the invention, the method comprises: receiving load demands from the one or more load responder components. The load demands may be received via the data communication lines, which connect the power controller with the loads. A load demand may contain information about a power need of the respective load.

According to an embodiment of the invention, the method comprises: receiving state change information from the one or more load responder components and/or from the one or more compensators. The load demands may be received via the data communication lines, which connect the power controller with the loads and the compensators. The state change information, for example, may describe that the corresponding load will increase and/or decrease its power demand in the future and/or that the corresponding compensator, such as an energy storage, is depleted.

According to an embodiment of the invention, the method comprises: receiving electric measurement information from the one or more load responder components and/or from the one or more compensators. The electric measurement information may be received via the data communication lines, which connect the power controller with the loads and the compensators. Electric measurement information may contain voltages, currents, active power, reactive power, etc. measured by the respective responder component and/or derived from such measurements by the respective responder component.

According to an embodiment of the invention, the method comprises: determining stabilizing commands and/or power control information from the load demands, the state change information and/or the electric measurement information with the power controller.

In general, the objective of the power controller is to maintain the voltage and frequency within the distribution grid and/or at the point of common coupling within allowed limits. These allowed limits may be provided in the power controller.

The power controller may determine compensations and/or reactions of the loads and compensators, which achieve this objective. Depending on the compensation required, such as encoded in the load demand, as well as based on the available reserve, such as encoded in the state change information from a compensator, setpoints may be determined, which for example provide frequency support, an active power and/or reactive power compensation. The stabilizing commands and/or the power control information may contain such setpoints. If it is not possible to completely compensate the load demand of a load, power control information may be determined, which for example informs a load to reduce its power consumption.

According to an embodiment of the invention, the method comprises: sending the stabilizing commands to the one or more compensator responder components and/or sending the power control information to the one or more load responder components. This information may be sent via the fast data communication lines, such as described above.

According to an embodiment of the invention, the method comprises: controlling the loads and/or the compensators based on the stabilizing commands and/or the power control information. Such a control may be performed by the controllers of the respective load and/or compensator.

Voltage and frequency may be seen as the main parameters of the control method performed by the power controller. The reliable operation of the industrial facility depends on their magnitude being within the allowed limits. During disturbances from the power grid or the one or more loads, their values can exceed the allowed limits, especially with a power grid with low short circuit power and low inertia due to changes in active and reactive power. This may affect the one or more loads leading to instabilities in the power grid and/or the industrial facility, for example emanating from protection related trips. During these critical situations, fast controlled compensation of active power and reactive power is provided by the method to guarantee system stability. The control method compensates changes in power components and arrests the voltage and frequency changes beyond the allowed limits. This allows process continuity. In particular, compensators such like battery storage system and load responders like hydrogen producing unit, which include electrolyser banks and storage as well as high power fuel cell, can be used for controlled compensation of active and reactive power.

Further aspects of the invention relate to a computer program, which, when being executed by a processor, is adapted for performing the method as described above and below, as well as to a computer-readable medium, in which such a computer program is stored.

For example, the method may be performed by a control system of the industrial facility, which may be composed of one or more controllers, each of which comprises a memory and a processor. Such controllers may comprise the power controller, the load responder components and/or the compensator responder components, which all may be controllers or at least parts or modules of controllers of the industrial facility.

A computer-readable medium may be a hard disk, an USB (Universal Serial Bus) storage device, a RAM (Random Access Memory), a ROM (Read Only Memory), an EPROM (Erasable Programmable Read Only Memory) or a FLASH memory. A computer-readable medium may also be a data communication network, e.g., the Internet, which allows downloading a program code. In general, the computer-readable medium may be a non-transitory or transitory medium.

A further aspect of the invention relates to a power controller adapted for performing the method such as described above and below. The power controller may be and/or may comprise one or more controller components. Each controller component may comprise a memory and a processor. Some or all of the power components may be provided by modules of controllers of the industrial facility. The controller components of the power controller may be interconnected by fast data communication lines and/or fibre optics-based data communication lines.

It has to be understood that features of the power controller as described in the above and in the following may be features of the industrial facility, the method, the computer program and the computer-readable medium, as described in the above and in the following, and vice versa.

These and other aspects of the invention will be apparent from and elucidated with reference to the embodiments described hereinafter.

### BRIEF DESCRIPTION OF THE DRAWINGS

The subject-matter of the invention will be explained in more detail in the following text with reference to exemplary embodiments which are illustrated in the attached drawings.

FIG. 1 schematically shows an industrial facility according to an embodiment of the invention.

FIG. 2 shows a flow diagram for a method for stabilizing voltage and/or frequency at a point of common coupling of an industrial facility.

The reference symbols used in the drawings, and their meanings, are listed in summary form in the list of reference symbols. In principle, identical parts are provided with the same reference symbols in the figures.

### DETAILED DESCRIPTION

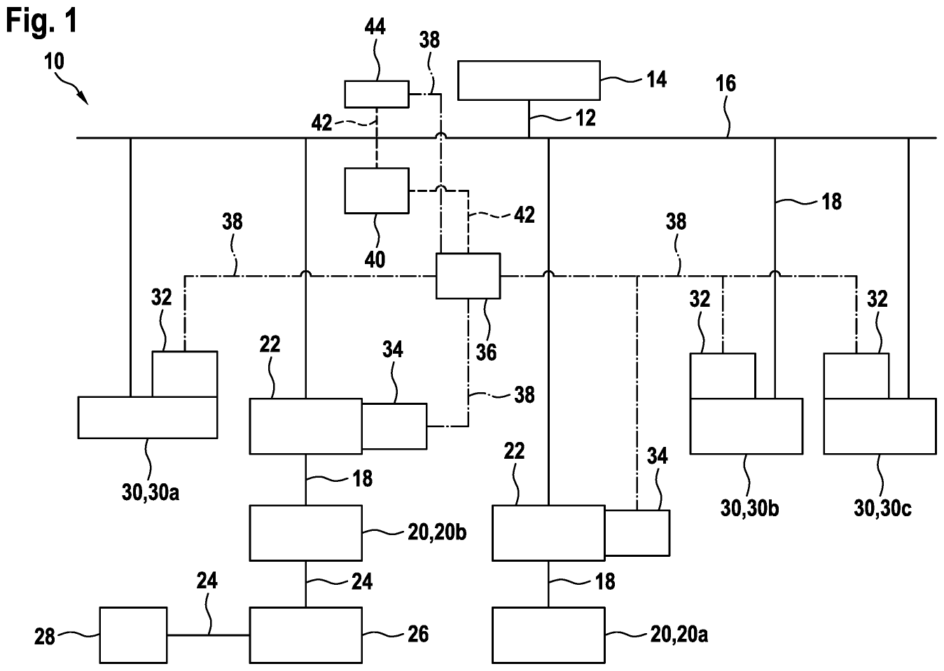

FIG. 1 shows an industrial facility 10, which is connected via a point of common coupling 12 with a power grid 14. The power grid 14 may be a power grid supplied by renewable energy sources and/or varying power sources.

The industrial facility 10 comprises a distribution grid 16 which is composed of power lines 18. The distribution grid 16 is connected with the power grid 14 at a point of common coupling 12. The distribution grid 16 may comprise one or more power lines 18, such as electric cables, for connecting the point of common coupling 12 with power electric components of the industrial facility 10. The connection may be via switchgear or a circuit breaker to a bus bar of the distribution grid 16.

The industrial facility 10 further comprises loads 20, 20a, 20b connected via a power electronics block 22 to the distribution grid 16. In general, a load may be any electric device consuming electric power. The load 20a is an arc furnace. The arc furnace 20a may produce heavy disturbances in the distribution grid 16 and may be compensated by the method and control system as described herein.

The load 20b comprises an electrolyser bank and/or fuel cell, which is connected via a pipeline 24 with a hydrogen tank 26. The electrolyser bank may be used for converting electrical energy into chemical energy stored in the hydrogen tank 26. The chemical energy of the hydrogen can be converted back into electrical energy by the fuel cell.

The industrial facility 10 also may comprise a hydrogen fed ore pelletizing plant 28, which is supplied by hydrogen from the hydrogen tank 26, for example via a further pipeline 24.

Each power electronics block 22 is connected via a power line 18 with the respective load 20. Each power electronics block 22 is adapted for converting a current from the distribution grid 16 into a current supplied to the respective load 20. A power electronics block 22 may comprise a rectifier, an inverter and/or a converter. In general, a power electronics block 22 may be composed of power electronic components, such as diodes, thyristors, and transistors, which are controlled by a respective controller. A power electronics block 22 may comprise power semiconductor switches, which may be controlled to provide the functionality of the power electronics block 22.

Furthermore, the industrial facility 10 comprises compensators 30 connected to the distribution grid 16. Each compensator 30 is adapted for stabilizing a voltage and/or a frequency in the distribution grid 16. In general, a compensator 30 may be any electric device stabilizing the voltage and/or frequency of the distribution grid 16 and therefore of the power grid 14. It has to be noted that there may be loads 20, such as the load 20b, which may be also seen as compensator 30.

The compensator 30a is a controlled energy storage system, such as a capacitor bank or a battery bank. The energy storage system 30a also may comprise a converter and/or power electronics block for controlling the energy flow from the distribution grid 16 into energy storage elements and vice versa.

The compensator 30b is a controlled mechanical compensator comprising a rotating inertia element, such as a heavy drum driven by an electric motor/generator together with a converter and/or power electronics block for controlling the energy flow from the distribution grid 16 into the drum and vice versa. The compensator 30b also may be a synchronous condenser with or without flywheel and/or may provide rotating inertia.

The compensator 30c is a controlled electric compensator comprising at least one of a resistor, inductor, and capacitor. An example for such a controlled compensator 30c providing active power compensators is a static watt compensator.

In general, controlled compensators 30 for reactive power include synchronous condenser, static var compensator, static synchronous compensator, dynamic voltage restorer, unified power flow controller, interline power flow controller, etc.

Each of the power electronics blocks 22 and the compensators 30 comprises a responder component 32, 34. The responder component 32, 34 may be a part of a controller of the respective power electronics blocks 22 or respective compensator 30. The responder component 32, 34 may be a module, such as a hardware or software module of such a controller. The compensators 30 have compensator responder components 32. The power electronics blocks 22 have load responder components 34.

The load responder components 32, 34 are in data communication with a power controller 36 of the industrial facility 10. The power controller 36 is responsible for controlling the active and reactive power provided by the loads 20 and compensators 30 to the distribution grid 16 and/or for keeping the voltage and frequency of the distribution grid 16 within limits.

The power controller 36 is connected with the responder 32, 34 via data communication lines 38 adapted for transmitting data packages within less than 25 us. For example, the protocol used may be a power link. The data communication lines 38 may be fibre optics data communication lines. In such a way, the data communication also may not be disturbed by electromagnetic fields generated in the industrial facility, such as by the power electronics blocks 22.

The industrial facility 10 further comprises an automation controller 40 adapted for controlling the process performed by the loads 20. The automation controller 40 is in data communication with the power controller 36 via a data communication line 42 with slower data communication than the data communication via the communication lines 38. For example, the automation controller 40 may be connected with the power controller 36 via a field bus.

Furthermore, the industrial facility 10 comprises a utility interface 44 for receiving external data provided to the industrial facility 10. Also, the utility interface 44 is in data communication with the power controller 36. This data communication may be done via a data communication line 38, such as described above. The utility interface 44 may be used for receiving information about the power grid, such as power sources connecting and disconnecting from the power grid, etc. Such information also may be used by the power controller 36 for coordinating the loads 20 and compensators 30. The utility interface 44 may also be in data communication with the automation controller 40, which may be done via a data communication line 42, such as described above, for example via a field bus.

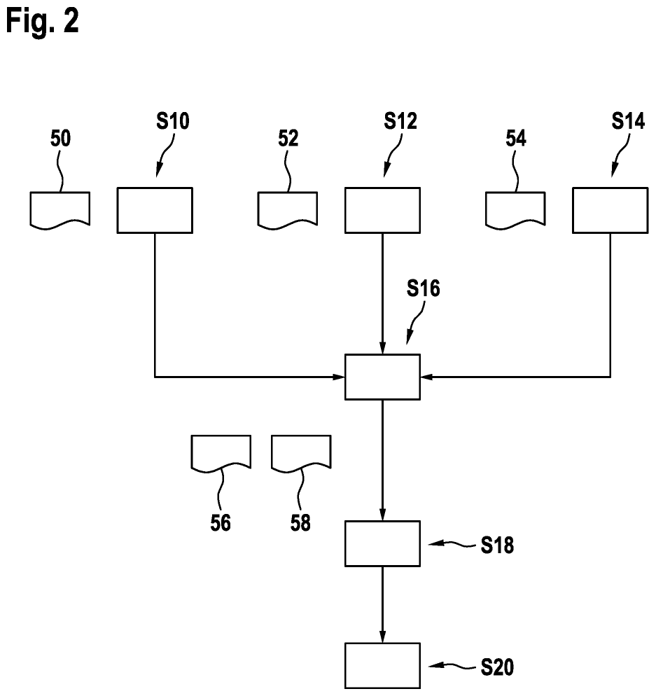

FIG. 2 shows a flow diagram for a method for stabilizing voltage and/or frequency at the point of common coupling 12 of the industrial facility 10 with the power grid 14. The method is performed by the power controller 36 together with the responder components 32, 34 and/or more general the controllers of the loads 20 and compensators 30.

In step S10, load demands 50 are received from the load responder components 34. A load demand 50 may contain information about a power need of the respective load 20.

In step S12, state change information 52 is received from the load responder components 34 and/or from the compensator responder components 32. The state change information 52, for example, may describe that the corresponding load 20 will increase and/or decrease its power demand in the future and/or is tripped due to protection related reasons and/or that the corresponding compensator 30, such as an energy storage, is depleted.

In step S14, electric measurement information 54 is received from the load responder components 34 and/or from the compensator responder components 32. Electric measurement information 54 may contain voltages, currents, active power, reactive power, etc. measured by the respective responder component and/or derived from such measurements by the respective responder component 32, 34.

The load demands 50, state change information 52 and electric measurement information 54 are transmitted via the data communication lines 38 to the power controller 36.

In step S16, the power controller 36 determines stabilizing commands 56 and/or power control information 58 from the load demands 50, the state change information 52 and/or the electric measurement information 54. In general, the objective of the power controller 36 is to maintain the voltage and frequency within the distribution grid 16 and/or at the point of common coupling 12 within allowed limits. These allowed limits may be provided in the power controller 36.

The power controller 36 determines compensations and/or reactions of the loads 20 and compensators 30, which achieve this objective. Depending on the compensation required, such as encoded in the load demands 50, as well as based on the available reserve, such as encoded in the state change information 52 from a compensator 30, setpoints may be determined, which for example provide an inertial response, an active power and/or reactive power compensation. An inertial response from a synchronous condenser may be automatic due to its rotating mass. An inertial response from other compensators, such as electrolyser or battery storage system, may have to be controlled by setpoints. The stabilizing commands 56 and/or the power control information 58 may contain such setpoints. If it is not possible to completely compensate the load demand 50 of a load 20, power control information 58 may be determined, which informs a load 20 to reduce its power consumption.

A stabilizing command 56 may be information on stabilizing the voltage and/or frequency in the distribution grid 16. For example, it may comprise a command for increasing or decreasing the voltage or providing active or reactive power support. The stabilizing command 56 may be executed by the respective compensator 30 via the control of the compensator responder component 32. In step S18, the power controller 36 sends the stabilizing commands 56 to compensator responder components 32 and sends the power control information 58 to the load responder components 34. This information is sent via the data communication lines 38.

In step S20, the compensator responder components 32 apply the stabilizing commands 56 to the respective compensator 30. The load responder component 34 apply the power control information 58 to the power electronics blocks 22 and to the loads 20.

The power electronics blocks 22, the loads 20 and/or the compensators 30 are controlled based on the stabilizing commands 56 and/or the power control information 58. Such a control may be performed by the controllers of the respective load and/or compensator.

During normal operating conditions, the automation controller 40 may communicate setpoints to individual load responder components 34 via the power controller 36. Based on the information exchange with load and compensator responder components 32, 34 as well as information about the distribution grid 16 from measurements, the power controller 36 adjusts the set points further and/or transmits the set points to the load and compensator responder components 32, 34 to maintain the voltage and frequency in the distribution grid 16 within allowed limits. The automation controller 40 also may provide information about load forecasts or weather dependent generation forecasts to the power controller 36, which can be used for further adjustment of set points for loads 20 and compensators 30.

During contingency situation, for example load shedding, the utility interface 44 may communicate directly with the power controller 36, which may control the loads 20 by overriding the setpoints from the automation controller 40 and/or may send setpoints directly to load and compensator responder components 32, 34. In another example, when there is a load rejection due to process or electric system related reasons, the power controller 36 receives this information from the respective load responder component 34 or interprets this directly based on the measurements.

Based on the available information, the power controller 36 may send stabilizing commands 56 to the compensator responder component 32 taking into account the amount of compensation required to maintain the voltage and frequency. When the compensation reserves have been reached, the power controller 36 sends power control information 58 to loads 20 like hydrogen units, to ramp up or down their production or receives support from battery storage system. By this combined action, the power controller 36 may bring the voltage and frequency within the allowed limits to allow process continuity. In a further example, when there are grid faults, voltage support to the distribution grid 16 may be initiated by the power controller 36 by changing the set points for compensators 30 and loads 20.

In such a way, voltage and frequency stability at the point of common coupling 12 may be achieved by using controlled loads 20 and compensators 30. Depending on the scenario i.e., voltage or frequency support or both, the combination provides inertial response, reactive power support and/or active power support. Inertia support may be provided automatically with a synchronous condenser in combination with a flywheel. By using hydrogen production units and/or battery storage system, controlled inertia support may be provided.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practising the claimed invention, from a study of the drawings, the disclosure, and the appended claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

1. An industrial facility connected to a power grid, the industrial facility comprising:
a distribution grid connected with the power grid at a point of common coupling;
at least one power electronics block;
at least one load connected via the at least one power electronics block to the distribution grid, each power electronics block adapted for converting a current from the distribution grid into a current supplied to the respective load and each power electronics block comprising a load responder component adapted for determining a load demand of the respective load;
at least one compensator connected to the distribution grid, each compensator being adapted for stabilizing a voltage and/or a frequency of a current in the distribution grid and each compensator including a compensator responder component adapted for receiving a stabilizing command and for applying the stabilizing command to the respective compensator;
a power controller in data communication with the one or more load responder components and the one or more compensator responder components, the power controller being adapted for receiving load demands from the one or more load responder components, for determining stabilizing commands from the load demands and for sending the stabilizing commands to the one or more compensator responder components, wherein the power controller (36) is connected with the one or more load responder components and the one or more compensator responder components (32) via fibre optics data communication lines;
an automation controller adapted for controlling the loads, wherein the automation controller is in data communication with the power controller via a data communication line, with slower data communication than the data communication between the power controller and the responder components.

2. The industrial facility of claim 1,
wherein the power controller is connected with the one or more load responder components and the one or more compensator responder components via data communication lines adapted for transmitting data packages within less than 25 μs.

3. (canceled)

4. The industrial facility of claim 1,
wherein one of the at least one compensator is a controlled electrical compensator comprising at least one of a resistor, inductor and capacitor.

5. The industrial facility of claim 1,
wherein one of the at least one compensator is a controlled mechanical compensator comprising a rotating inertia element.

6. The industrial facility of claim 1,
wherein one of the at least one compensator is a controlled energy storage system.

7. The industrial facility of claim 1,
wherein the power electronics block comprises at least one of a rectifier and inverter.

8. The industrial facility of claim 1,
wherein one of the at least one load is an arc furnace.

9. The industrial facility of claim 1,
wherein one of the at least one load comprises an electrolyser bank and/or fuel cell.

10. (canceled)

11. The industrial facility of claim 1, further comprising:
a utility interface for receiving external data provided to the industrial facility;
wherein the utility interface is in data communication with the power controller.

12. A method for stabilizing voltage and/or frequency at a point of common coupling of an industrial facility with a power grid having a distribution grid connected with the power grid at a point of common coupling:
at least one power electronics block;
at least one load connected via the at least one power electronics block to the distribution grid, each power electronics block adapted for converting a current from the distribution grid into a current supplied to the respective load and each power electronics block comprising a load responder component adapted for determining a load demand of the respective load;
at least one compensator connected to the distribution grid, each compensator being adapted for stabilizing a voltage and/or a frequency of a current in the distribution grid and each compensator including a compensator responder component adapted for receiving a stabilizing command and for applying the stabilizing command to the respective compensator;
a power controller in data communication with the one or more load responder components and the one or more compensator responder components, the power controller being adapted for receiving load demands(50) from the one or more load responder components, for determining stabilizing commands from the load demands and for sending the stabilizing commands to the one or more compensator responder components, wherein the power controller (36) is connected with the one or more load responder components and the one or more compensator responder components (32) via fibre optics data communication lines;
an automation controller adapted for controlling the loads, wherein the automation controller is in data communication with the power controller via a data communication line, with slower data communication than the data communication between the power controller and the responder components;
the method comprising:
receiving load demands from the one or more load responder components with the power controller;
determining stabilizing commands from the load demands with the power controller;
sending the stabilizing commands to the one or more compensator responder components.

13. A computer program, which, when being executed by a processor, is adapted for performing a method for stabilizing voltage and/or frequency at a point of common coupling of an industrial facility with a power grid having a distribution grid connected with the power grid at a point of common coupling;
at least one power electronics block;
at least one load connected via the at least one power electronics block to the distribution grid, each power electronics block adapted for converting a current from the distribution grid into a current supplied to the respective load and each power electronics block comprising a load responder component adapted for determining a load demand of the respective load;
at least one compensator connected to the distribution grid, each compensator being adapted for stabilizing a voltage and/or a frequency of a current in the distribution grid and each compensator including a compensator responder component adapted for receiving a stabilizing command and for applying the stabilizing command to the respective compensator;
a power controller in data communication with the one or more load responder components and the one or more compensator responder components, the power controller being adapted for receiving load demands(50) from the one or more load responder components, for determining stabilizing commands from the load demands and for sending the stabilizing commands to the one or more compensator responder components, wherein the power controller (36) is connected with the one or more load responder components and the one or more compensator responder components (32) via fibre optics communication lines;
an automation controller adapted for controlling the loads, wherein the automation controller is in data communication with the power controller via a data communication line, with slower data communication than the data communication between the power controller and the responder components;
the method comprising:
receiving load demands from the one or more load responder components with the power controller;
determining stabilizing commands from the load demands with the power controller;
sending the stabilizing commands to the one or more compensator responder components.

14. A computer-readable medium, in which a computer program when being executed by a processor, is adapted for performing having a method for stabilizing voltage and/or frequency at a point of common coupling of an industrial facility with a power grid having a distribution grid connected with the power grid at a point of common coupling:
at least one power electronics block;
at least one load connected via the at least one power electronics block to the distribution grid, each power electronics block adapted for converting a current from the distribution grid into a current supplied to the respective load and each power electronics block comprising a load responder component adapted for determining a load demand of the respective load;
at least one compensator connected to the distribution grid, each compensator being adapted for stabilizing a voltage and/or a frequency of a current in the distribution grid and each compensator including a compensator responder component adapted for receiving a stabilizing command and for applying the stabilizing command to the respective compensator;
a power controller in data communication with the one or more load responder components and the one or more compensator responder components, the power controller being adapted for receiving load demands(50) from the one or more load responder components, for determining stabilizing commands from the load demands and for sending the stabilizing commands to the one or more compensator responder components, wherein the power controller (36) is connected with the one or more load responder components and the one or more compensator responder components (32) via fibre optics data communication lines;
an automation controller adapted for controlling the loads, wherein the automation controller is in data communication with the power controller via a data communication line, withe slower data communication than the data communication between the power controller and the responder components;
the method comprising:
receiving load demands from the one or more load responder components with the power controller;
determining stabilizing commands from the load demands with the power controller;
sending the stabilizing commands to the one or more compensator responder components is stored.

15. A power controller adapted for performing the method for stabilizing voltage and/or frequency at a point of common coupling of an industrial facility with a power grid having a distribution grid connected with the power grid at a point of common coupling:
at least one power electronics block;
at least one load connected via the at least one power electronics block to the distribution grid, each power electronics block adapted for converting a current from the distribution grid into a current supplied to the respective load and each power electronics block comprising a load responder component adapted for determining a load demand of the respective load;
at least one compensator connected to the distribution grid, each compensator being adapted for stabilizing a voltage and/or a frequency of a current in the distribution grid and each compensator including a compensator responder component adapted for receiving a stabilizing command for applying the stabilizing command to the respective compensator; a power controller in data communication with the one or more load responder components and the one or more compensator responder components, the power controller being adapted for receiving load demands(50) from one or more loads responder components, for determining stabilizing commands from the load demands and for sending the stabilizing commands to the one or more compensator responder components, wherein the power controller (36) is connected with the one or more load responder components and the one or more compensator responder components (32) via fibre optics data communication lines;
an automation controller adapted for controlling the loads, wherein the automation controller is in data communication with the power controller via a data communication line, with slower data communication than the data communication between the power controller and the responder components;
the method comprising:
receiving load demands from the one or more load responder components with the power controller;
determining stabilizing commands from the load demands with the power controller;
sending the stabilizing commands to the one or more compensator responder components.

16. The industrial facility of claim 2,
wherein one of the at least one compensator is a controlled electrical compensator comprising at least one of a resistor, inductor and capacitor.

17. The industrial facility of claim 2,
wherein one of the at least one compensator is a controlled mechanical compensator comprising a rotating inertia element.

18. The industrial facility of claim 2,
wherein one of the at least one compensator is a controlled energy storage system.

19. The industrial facility of claim 2,
wherein the power electronics block comprises at least one of a rectifier and inverter.

20. The industrial facility of claim 2,
wherein one of the at least one load is an arc furnace.
